(19) United States
(12) Patent Application Publication
(10) Pub. No.: US 2026/0320952 A1
(43) Pub. Date: Oct. 15, 2026

(54) PERSONALIZED WARDROBE MANAGEMENT SYSTEM OVER A COMMUNICATIONS NETWORK

(71) Applicants: Everett Lee Hunt, St. Petersburg, FL (US); Kendra Hunt, St. Petersburg, FL (US)

(72) Inventors: Everett Lee Hunt, St. Petersburg, FL (US); Kendra Hunt, St. Petersburg, FL (US)

(21) Appl. No.: 19/645,081

(22) Filed: Apr. 10, 2026

Related U.S. Application Data
(60) Provisional application No. 63/786,680, filed on Apr. 10, 2025.

(51) Int. Cl. G06T 19/20; G06Q 30/0601; G06T 19/00

(52) U.S. Cl. CPC G06T 19/20; G06Q 30/0631; G06Q 30/06432; G06T 19/006; G06T 2200/24; G06T 2210/16; G06T 2219/024; G06T 2219/2021

(57) ABSTRACT

A personalized wardrobe management system includes a user interface that allows users to upload digital images of clothing and footwear items from a user's personal wardrobe, an image processing module for digitally processing the uploaded images, an outfit construction module enabling drag-and-drop interaction for users to select and layer multiple digital images of clothing, a styling recommendation engine, an outfit tracking and history module that records and displays user outfit choices and usage frequency, a wardrobe organization module to sort, filter, and provide search functionality, a rating module to receive user feedback on wardrobe items and outfit combinations, a communication module to connect users with professional stylists through an integrated paid consultation service, and, wherein the system is accessible via a subscription-based model offering differentiated access levels to features based on subscription status.

### CROSS-REFERENCE TO RELATED APPLICATIONS

This patent application claims priority to provisional patent application No. 63/786,680 titled “Personalized Wardrobe Management System Over a Communications Network” filed Apr. 10, 2025. The subject matter of provisional patent application No. 63/786,680 is hereby incorporated by reference in its entirety.

### STATEMENT REGARDING FEDERALLY SPONSORED RESEARCH OR DEVELOPMENT

### Not Applicable.

### INCORPORATION BY REFERENCE OF MATERIAL SUBMITTED ON A COMPACT DISC

Not Applicable.

### TECHNICAL FIELD

The claimed subject matter relates to the field of electronic commerce systems and methods and, more specifically, the claimed subject matter relates to the field of systems that facilitate the management of wardrobes. The claimed subject matter further pertains to systems incorporating image processing, augmented reality visualization, user interface interaction, and data analytics to facilitate virtual try-on, outfit generation, and personalized styling recommendations.

### BACKGROUND

Traditionally, individuals manage their wardrobes manually, relying on physical storage methods and personal memory to track clothing items and assemble outfits. With increasing reliance on digital solutions, various mobile and web-based applications have emerged attempting to digitize wardrobe management. Current virtual wardrobe applications typically allow users to digitally catalog their clothing items by manually uploading images and organizing these into categories. Some of these applications offer basic organization features, enabling users to browse through digital images of clothing and accessories they own. Others have introduced features like outfit planners that allow users to match items visually; however, such systems frequently rely solely on static images with minimal interactive or dynamic functionalities.

While certain applications attempt to provide styling advice or outfit suggestions, these recommendations are often limited and generic, lacking significant personalization. Typically, styling suggestions do not adequately account for a user's unique body type, personal style preferences, and occasion-based clothing selection criteria. Most existing platforms fail to provide effective visual representation tools that can accurately and realistically depict how clothing and accessories might look on an individual user, instead relying on simplistic overlays or templates that are unrepresentative of actual fit and appearance. Additionally, current digital wardrobe tools rarely support the efficient integration of professional stylist input, leaving users without access to expert styling guidance when desired.

Moreover, existing solutions frequently lack comprehensive organization capabilities, limiting users' ability to efficiently sort, filter, or search through their digital wardrobe based on meaningful and personalized parameters such as frequency of wear, seasonal applicability, or event suitability. Users also struggle to effectively track outfit usage history, resulting in repetitive or underutilized clothing combinations, which contributes to inefficient wardrobe management and decision-making fatigue. Furthermore, most existing wardrobe applications lack robust interfaces for interactive, user-friendly outfit assembly through intuitive drag-and-drop or visual overlay functionalities.

Consequently, the current state of wardrobe management applications presents significant limitations, including inadequate virtual visualization, limited personalized styling recommendations, insufficient tracking capabilities, poor integration of professional styling expertise, and rudimentary organizational functionalities. There remains a clear need in the art for a more comprehensive, interactive, and personalized virtual wardrobe management solution.

### BRIEF SUMMARY

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a personalized wardrobe management system over a communications network is disclosed. The system includes a user interface configured to allow users to upload digital images of clothing and footwear items from a user's personal wardrobe, an image processing module configured to: (i) digitally process uploaded images to remove backgrounds and isolate clothing and footwear items; (ii) create virtual overlays of clothing and footwear items onto a digital representation of the user's body, an outfit construction module enabling drag-and-drop interaction for users to select and layer multiple digital images of clothing and footwear items to create virtual outfit combinations, a styling recommendation engine configured to generate personalized outfit recommendations based on user preferences, historical outfit usage, item compatibility, and fashion criteria, an outfit tracking and history module configured to record and display user outfit choices and usage frequency, a wardrobe organization module configured to sort, filter, and provide search functionality for the uploaded clothing and footwear items based on user-defined and automatically-generated categories, a rating module configured to receive user feedback on wardrobe items and outfit combinations, and provide analytics based on user interactions, a communication module configured to connect users with professional stylists through an integrated paid consultation service, and, wherein the system is accessible via a subscription-based model offering differentiated access levels to features based on subscription status.

In another embodiment, a computer-implemented method is provided for generating a physically accurate virtual rendering of clothing on a user in a networked computing environment. The method includes capturing, by at least one image sensor of a client computing device, a real-time image or video stream of a user, and acquiring three-dimensional spatial data of the user using a depth sensor or LiDAR sensor. A processing unit, in conjunction with a graphics processing unit (GPU), generates a three-dimensional mesh model of the user based on the captured image data and spatial data. Digital image data corresponding to clothing or footwear items is received from a remote server and processed using a convolutional neural network to perform pixel-level segmentation that removes background data and isolates garment regions. The isolated garment regions are transformed into parameterized garment models including dimensional attributes and material properties, and a physics-based simulation engine executed by the GPU applies cloth simulation algorithms to deform the garment models relative to the mesh model of the user based on gravitational forces and collision detection. A composite image is rendered in real time showing the deformed garment models overlaid on the user, with continuous updates based on detected user movement. Interaction data associated with user selections and garment combinations is stored in memory and processed by a machine learning-based recommendation engine to generate a ranked set of outfit configurations, which are transmitted to the client computing device for display, thereby improving rendering accuracy and computational efficiency in real-time garment visualization.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a personalized wardrobe management system over a communications network, in accordance with one embodiment.

FIG. 2 is a block diagram showing the data flow of the process for providing personalized wardrobe management over a communications network, according to one embodiment.

FIG. 3 is a flow chart depicting the general control flow of a process for providing personalized wardrobe management over a communications network, according to one embodiment.

FIG. 4 is a block diagram depicting a system including an example computing device and other computing devices.

FIG. 5 is a flowchart depicting an example control flow and data transformation process for generating a physically accurate virtual rendering of clothing items on a user, in accordance with one embodiment.

The aforementioned figures will hence depict various embodiments claimed by the applicant.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting, reordering, or adding additional stages or components to the disclosed methods and devices. Accordingly, the following detailed description does not limit the disclosed embodiments. Instead, the proper scope of the disclosed embodiments is defined by the appended claims.

The claimed embodiments represent a significant advancement over the prior art by addressing key limitations inherent in previous wardrobe management solutions. Unlike conventional digital closet systems, the claimed embodiments provide advanced visualization tools enabling realistic and accurate virtual try-on of clothing and accessories via a virtual closet. By facilitating interactive overlaying and drag-and-drop features, users gain an understanding of how items fit and appear on their individual bodies, substantially improving the user's confidence in outfit choices compared to static or generic visual representations offered by existing solutions, improving accuracy of visualization, and reducing reliance on static representations.

Additionally, the claimed embodiments overcome deficiencies related to limited personalization and insufficient wardrobe organization found in prior art applications. Through integrating professional stylist input directly within the platform, users benefit from tailored style guidance that accounts for their personal preferences, physical attributes, and intended usage scenarios. The improved functionality for sorting, filtering, searching, and tracking outfit history enables users to effectively manage their wardrobe, reducing decision-making fatigue and promoting more efficient clothing utilization. Collectively, these enhancements not only offer users a more personalized and engaging experience but also substantially streamline wardrobe management tasks, marking a clear departure from the shortcomings present in existing wardrobe management technologies.

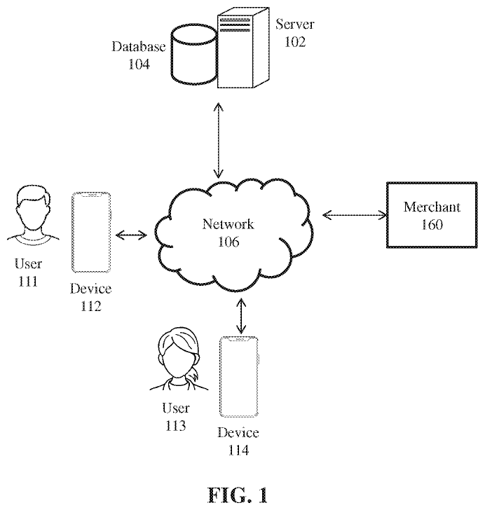

Referring now to the drawing figures in which like reference designators refer to like elements, there is shown in FIG. 1 an illustration of a block diagram showing the network architecture of a system 100 and method for providing personalized wardrobe management over a communications network in accordance with one embodiment. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, a satellite communications network, or any combination of the above. Server 102 is a central controller or operator for functionality of the disclosed embodiments, namely, providing personalized wardrobe management.

FIG. 1 includes mobile computing devices 112, 114, which may be smart phones, mobile phones, tablet computers, handheld computers, wearable computers, device-paired or independently networked smartwatches, laptops, or the like. Mobile computing devices 112, 114 correspond to users 111 and 113, respectively. In another embodiment, mobile computing devices 112, 114, are workstations, desktop computers, servers, laptops, all-in-one computers, or the like. In another embodiment, mobile computing devices 112, 114, are AR or VR systems that may include display screens, headsets, heads up displays, helmet mounted display screens, tracking devices, or the like. FIG. 1 also shows a server, computer, or computing device 160, which correspond to a merchant, such as a clothing item merchant, clothing store, clothing web site, etc. Devices 112, 114, 160 may be communicatively coupled with network 106 in a wired or wireless fashion.

FIG. 1 further shows that server 102 includes a database or repository 104, which may be a relational database comprising a Structured Query Language (SQL) or NoSQL database. Devices 112, 114, 160 may also each include their own database. The repository 104 serves data from a database, which is a repository for data used by server 102 and devices 112, 114, 160 during the course of operation of the disclosed embodiments. Database 104 may be distributed over one or more nodes or locations that are connected via network 106.

The database 104 may include a user record for each user 111 or 113. A user record may include contact/identifying information for the user (name, address, telephone number(s), email address, etc.), information pertaining to clothing items associated with the user, contact/identifying information for the sources of the clothing, electronic payment information for the user, sales transaction data associated with the user, etc. A user record may also include a unique identifier for each user, a residential address for each user, the current location of each user (based on location-based services from the user's mobile computer) and a description of past clothing items of each user. A user record may further include demographic data for each user, such as age, sex, income data, race, color, marital status, etc. A user record may further include sales transaction data, as described below.

Sales transaction data may include one or more service identifiers (such as SKUs), one or more service amounts, buyer contact/identifying information, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

The database 104 may include a clothing item record for each clothing item. A clothing item record may include photos of the clothing item, a written description, a size, a length and width, clothing item measurements, a list of colors included, a list of events and places to which it is appropriate to wear such item, etc. A clothing items record may also include when the item was worn last, dates, locations, and times of each time it was worn, photographs of the last time it was worn, etc.

FIG. 1 shows an embodiment wherein networked computing devices 112, 114, 160 interact with server 102 and repository 104 over the network 106. It should be noted that although FIG. 1 shows only the networked computers 112, 114, 160 and 102, the system of the disclosed embodiments supports any number of networked computing devices connected via network 106. Further, server 102, and units 112, 114, 160 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 112, 114, 160. Further, server 102 and its functionality, according to a preferred embodiment, can be realized in a centralized fashion in one computer system or in a distributed fashion wherein different elements are spread across several interconnected computer systems.

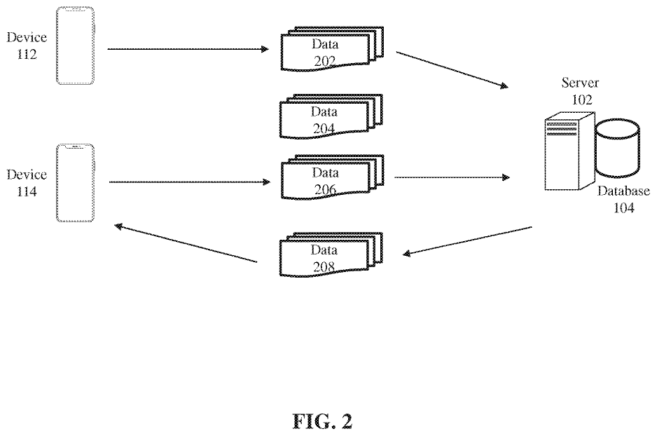

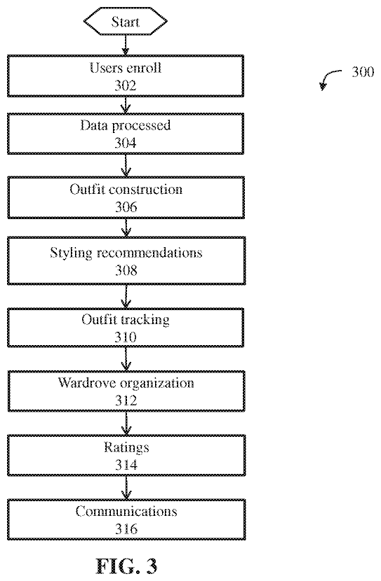

The process of providing personalized wardrobe management over a communications network will now be described with reference to FIGS. 2-3 below. FIGS. 2-3 depict the data flow and control flow of the general process (and sub-processes) for providing personalized wardrobe management over a communications network 106, according to one embodiment. In FIGS. 2-3, any data provided by user 111 via device 112, is referred to as data 202, and any data provided by server 102 to user 111 via device 112, is referred to as data 204. Further, any data provided by user 113 via device 114 is referred to as data 206, and any data provided by server 102 to user 113 via device 114, is referred to as data 208.

FIG. 3 is a flow chart depicting the general control flow of a process for providing personalized wardrobe management over a communications network, according to one embodiment.

The process of the disclosed embodiments begins in FIG. 3 with step 302 (see flowchart 300), wherein the users 111 and 113 may enroll or register with server 102. In the course of enrolling or registering, the users may enter data into their device by manually entering data into a mobile application via keypad, touchpad, or via voice. In the course of enrolling or registering, the users may enter any data that may be stored in a user record, as defined above. Also, in the course of enrolling or registering, the server 102 may generate a user record for each registering user and store the user record in an attached database, such as database 104. In step 302, the users 111 and 113 utilize a user interface on their mobile application configured to allow users to upload digital images of clothing and footwear items from a user's personal wardrobe. During the registration phase, users create personalized profiles by manually inputting relevant personal details and preferences and utilize the provided interface to upload digital images of clothing and footwear items from their personal wardrobes. Uploaded images are typically sourced directly from a user's mobile device, tablet, desktop, or wearable computing device, and can be captured directly via integrated camera functionality or selected from previously stored digital photos. Each uploaded item is cataloged within the user's personalized digital wardrobe, establishing a comprehensive and easily navigable digital inventory of their personal clothing and footwear collection.

In step 304, an image processing module digitally processes the uploaded images to remove backgrounds and isolate clothing, and footwear items and creates virtual overlays of clothing and footwear items onto a digital representation of the user's body. The module employs computer vision techniques such as background removal, edge detection, segmentation algorithms, and image refinement processes, ensuring that each clothing or footwear item is presented in clear detail, suitable for accurate virtual fitting. Upon successful isolation, the module creates virtual overlays that realistically place the processed digital representations of clothing and footwear items onto a digital depiction of the user's own body. In some embodiments, this digital representation is generated via augmented reality (AR) technology, facilitating real-time video feeds or images of users. Such virtual overlays enable highly accurate visualization, allowing users to gain precise insight into how each item will fit and appear when worn, significantly improving the realism and effectiveness compared to static and simplified prior art visualizations. Hence, a virtual closet is provided to the user.

In step 306, an outfit construction module enables drag-and-drop interaction for users to select and layer multiple digital images of clothing and footwear items to create virtual outfit combinations. The outfit construction module provides an interactive environment that allows users to intuitively assemble virtual outfit combinations through drag-and-drop functionality. Users can seamlessly select individual clothing items and footwear from their digitized wardrobes and visually layer them onto their personal virtual representations in user-defined arrangements. The drag-and-drop interface supports multiple layers and combinations, accommodating various outfit structures involving base layers, outerwear, footwear, and accessories. The intuitive user interface permits rapid iteration of outfit options via a virtual closet, enhancing the creativity, convenience, and usability of digital wardrobe management and improving overall user engagement in assembling personalized outfits.

In step 308, a styling recommendation engine generates personalized outfit recommendations based on user preferences, historical outfit usage, item compatibility, and fashion criteria. Recommendations generated by the engine incorporate numerous criteria, including explicit user preferences, historical outfit usage patterns, compatibility among clothing and footwear items based on fashion principles, current fashion trends, weather conditions, and scheduled or anticipated user events. By dynamically analyzing both individual user data and broader fashion parameters, the recommendation engine significantly surpasses generic prior art methods, delivering highly tailored outfit suggestions that accurately reflect each user's unique tastes, body type, lifestyle, and real-world clothing needs.

In certain embodiments, the styling recommendation engine is further configured to automatically select one or more complete outfit combinations from the user's digital wardrobe without user input. Such automatic selection may be performed periodically, including on a daily or scheduled basis, by analyzing stored wardrobe data, historical usage patterns, user preferences, contextual data, and compatibility rules. The automatically selected outfits may be presented to the user as suggested outfits to wear, thereby reducing user decision-making effort and improving wardrobe utilization.

In step 310, an outfit tracking and history module records and displays user outfit choices and usage frequency. Every virtual outfit combination assembled and worn by users is logged, along with corresponding dates, frequency of usage, and contextual details regarding where or how each outfit was utilized. This historical tracking capability permits users to visualize their wardrobe habits, monitor clothing utilization patterns, identify frequently or infrequently worn items, and efficiently manage wardrobe rotations. Consequently, users benefit from reduced decision-making fatigue and enhanced clarity regarding their wardrobe's practical utilization over time.

In step 312, a wardrobe organization module sorts, filters, and provides search functionality for the uploaded clothing and footwear items based on user-defined and automatically-generated categories. Users may customize and apply multiple sorting and filtering criteria such as clothing type, color, material, seasonal appropriateness, frequency of use, and user-defined events or occasions. The module further supports automatically generated categories, derived through data-driven analysis of clothing characteristics and historical usage patterns. This robust organizational capability greatly enhances ease of access to individual items and streamlines outfit assembly processes.

In step 314, a rating module receives user feedback on wardrobe items and outfit combinations, and provides analytics based on user interactions. Users provide ratings, comments, or detailed reviews for items and outfits, contributing to a personalized analytics profile. This analytics capability aggregates user interactions to generate valuable insights, highlighting favorite items, least-used pieces, optimal outfit pairings, and gaps in the wardrobe. Such personalized analytics guide users toward informed decisions about maintaining, replacing, or purchasing new wardrobe elements.

In step 316, a communication module connects users with professional stylists through an integrated paid consultation service. The system is accessible via a subscription-based model offering differentiated access levels to features based on subscription status. Users can request consultations, exchange messages, share virtual wardrobes, and receive bespoke styling guidance directly from expert stylists within the platform. The entire personalized wardrobe management system is accessible through a subscription-based model offering differentiated access levels. Free users can experience basic organization and outfit visualization, while premium subscribers gain enhanced functionalities, including advanced analytics, greater wardrobe upload capacities, augmented reality virtual fitting, sophisticated personalized recommendations, priority access to professional stylist consultations, and integrated social sharing functionalities for feedback on outfit selections from their social networks.

In certain embodiments, the system further includes a community interaction platform accessible via the application or associated website, wherein users may periodically, including on a weekly basis, submit selected outfit configurations to a shared fashion community. Other users within the community may evaluate submitted outfits through voting, ranking, or scoring mechanisms. Based on such evaluations, one or more submitted outfits may be selected as winning entries, and corresponding users may receive rewards, including prizes, monetary awards, or other incentives. This community-driven evaluation mechanism promotes user engagement and provides additional feedback signals that may be incorporated into the system's analytics and recommendation processes. Voting mechanisms may include weighted ranking and scoring. Reward delivery may include credits, payments, etc.

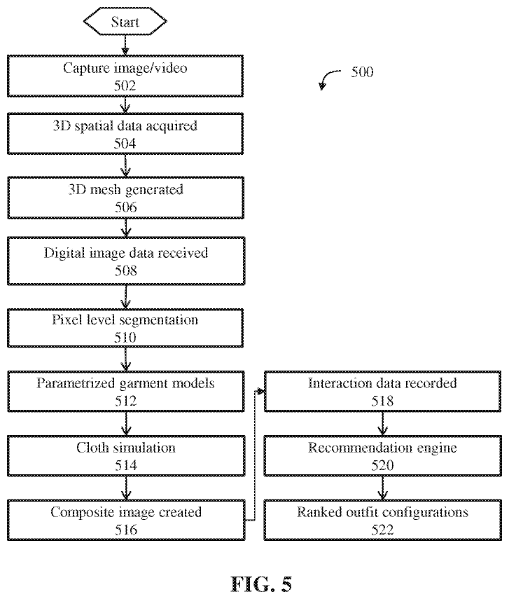

FIG. 5 is a flowchart depicting an example control flow and data transformation process for generating a physically accurate virtual rendering of clothing items on a user, in accordance with one embodiment. The flowchart illustrates the sequential interaction of image capture components, depth sensing elements, processing units, and graphics processing resources to generate a three-dimensional mesh model of a user, perform machine learning-based segmentation of clothing items, transform the clothing items into parameterized models, and apply physics-based simulation and real-time rendering techniques. The figure further depicts the collection and processing of user interaction data and contextual data for generating personalized outfit recommendations, as well as the transmission and sharing of rendered outputs across networked computing devices.

Referring now to FIG. 5, there is shown a flowchart 500 illustrating a process for generating a physically accurate virtual rendering of clothing items on a user utilizing sensor-derived data, machine learning-based image processing, and graphics processing unit (GPU)-accelerated simulation techniques, in accordance with one embodiment. The process depicted in FIG. 5 is implemented through coordinated operation of client computing devices, one or more remote servers, and specialized hardware components including image sensors, depth sensors, and graphics processing units.

In step 502, a client computing device captures a real-time image or video stream of a user utilizing at least one image sensor, such as a camera integrated into a mobile device, wearable device, or augmented reality system. Concurrently, in step 504, the client computing device acquires three-dimensional spatial data corresponding to the user using a depth sensing mechanism, such as a time-of-flight sensor or LiDAR sensor. The acquired spatial data represents the geometric contours and surface topology of the user and is continuously updated as the user moves within the field of view of the sensors.

In step 506, a processing unit, in conjunction with a GPU, generates a three-dimensional mesh model of the user based on the real-time image or video stream and the acquired spatial data. The mesh model represents a structured geometric framework comprising vertices, edges, and surfaces that define the user's body in three-dimensional space. This transformation from raw sensor input into a structured mesh model provides a machine-interpretable representation suitable for further computational processing.

In step 508, the system receives digital image data corresponding to one or more clothing or footwear items from a remote server via a packet-switched network. These digital assets are retrieved from a database and may include high-resolution images and associated metadata describing garment characteristics. In step 510, an image processing module executes a convolutional neural network trained on labeled garment datasets to perform pixel-level segmentation of the received image data. This segmentation removes background elements and isolates garment regions with high precision, producing refined digital representations of the clothing items.

In step 512, the system transforms the segmented garment regions into parameterized garment models. These models include dimensional attributes and material properties such as elasticity, stiffness, and friction coefficients. Such parameters enable the garments to behave in a physically consistent manner during simulation. This transformation converts static image data into structured, simulation-ready representations that can interact dynamically with the three-dimensional mesh model of the user.

In step 514, a physics-based simulation engine executed by the GPU applies cloth simulation algorithms to the parameterized garment models. The simulation accounts for gravitational forces, user movement, and collision detection between the garment models and the mesh model of the user. The simulation ensures that garments deform realistically, avoiding interpenetration and accurately conforming to the user's body geometry. These operations are performed at a frame rate sufficient to support real-time interaction, such as at least 24 frames per second.

In step 516, the GPU renders a composite image comprising the simulated garment models overlaid on the three-dimensional mesh model of the user. The rendering is continuously updated in response to detected user movement, with the mesh model and garment deformations recalculated dynamically based on updated sensor input. This enables real-time visualization of clothing items as they would appear when worn by the user under varying conditions and poses.

In step 518, the system records interaction data in non-transitory memory. The interaction data includes user selections of garments, combinations of clothing items, temporal sequencing of outfit configurations, and durations associated with each selection. This data forms a structured dataset representing user behavior and preferences over time.

In step 520, a recommendation engine executed on a remote server processes the stored interaction data using a trained machine learning model. The model analyzes historical usage patterns, user preferences, and contextual data including weather conditions, geographic location, calendar events, and time of day to generate a ranked set of outfit configurations. These recommendations are dynamically tailored based on both user-specific data and external contextual inputs. Recommendations can be automatically selected and scheduled.

In step 522, the ranked outfit configurations are transmitted over the network to the client computing device for display. In certain embodiments, the system further enables transmission of rendered composite images or selected outfit configurations to remote computing devices or network-based platforms, thereby facilitating sharing and feedback. Communication between users and third-party entities may also be supported through integrated communication modules.

The process illustrated in FIG. 5 demonstrates a sequence of operations in which raw sensor data is transformed into structured geometric models, processed through machine learning-based segmentation, converted into parameterized physical models, and subjected to GPU-accelerated simulation and rendering. The coordinated interaction of these components produces a dynamic and responsive system that improves computational efficiency, rendering accuracy, and real-time interactivity. The integration of sensor-derived data acquisition, neural network-based image processing, and physics-based simulation reflects a technical implementation that operates at multiple levels of the computing stack, including hardware, firmware, and software layers, thereby enabling enhanced functionality not achievable through conventional data organization or presentation techniques.

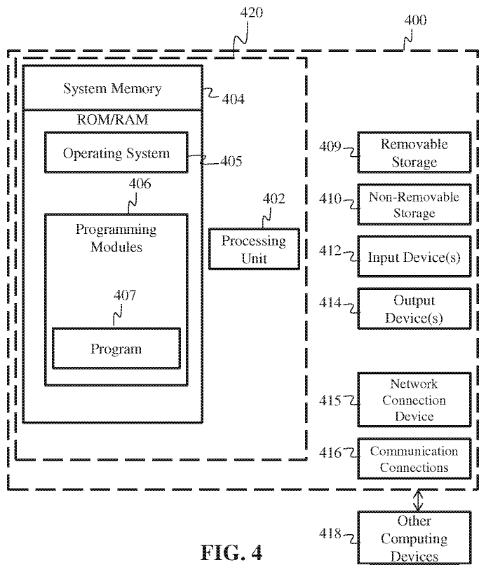

FIG. 4 is a block diagram of a system including an example computing device 400 and other computing devices. Consistent with the embodiments described herein, the aforementioned actions performed by 112, 114, 160, 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g., random-access memory (RAM)), non-volatile (e.g., read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of 112, 114, 160, 102. Furthermore, embodiments may be practiced in conjunction with a graphics library, other operating systems, or any other application program and are not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable, and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter, or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g., program module 407) may perform processes including, for example, one or more of the stages of the process 300, as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general-purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages, and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A personalized wardrobe management system comprising:
(a) a user interface configured to allow users to upload digital images of clothing and footwear items from a user's personal wardrobe;
(b) an image processing module configured to: (i) digitally process uploaded images to remove backgrounds and isolate clothing and footwear items; (ii) create virtual overlays of clothing and footwear items onto a digital representation of the user's body;
(c) an outfit construction module enabling drag-and-drop interaction for users to select and layer multiple digital images of clothing and footwear items to create virtual outfit combinations;
(d) a styling recommendation engine configured to generate personalized outfit recommendations based on user preferences, historical outfit usage, item compatibility, and fashion criteria;
(e) an outfit tracking and history module configured to record and display user outfit choices and usage frequency;
(f) a wardrobe organization module configured to sort, filter, and provide search functionality for the uploaded clothing and footwear items based on user-defined and automatically-generated categories;
(g) a rating module configured to receive user feedback on wardrobe items and outfit combinations, and provide analytics based on user interactions;
(h) a communication module configured to connect users with professional stylists through an integrated paid consultation service; and
(i) wherein the system is accessible via a plurality of subscription tiers providing differing access to system functionalities.

2. The system of claim 1, wherein the virtual try-on interface utilizes augmented reality technology to visually overlay clothing items onto a real-time image or video feed of the user.

3. The system of claim 1, further comprising functionality for automatic background removal from user-uploaded clothing images, creating accurate digital representations suitable for virtual fitting.

4. The system of claim 1, further comprising a professional stylist integration feature allowing users to request, communicate with, and receive personalized outfit recommendations from professional stylists.

5. The system of claim 1, wherein the virtual closet organizer includes sorting and filtering options based on clothing type, color, seasonality, frequency of wear, or user-defined events.

6. The system of claim 1, further comprising an analytics component configured to track and display historical usage of outfits, individual clothing items, or combinations thereof.

7. The system of claim 1, wherein the drag-and-drop outfit selection interface supports layering multiple clothing items and accessories in a user-defined arrangement.

8. The system of claim 1, wherein the styling recommendation engine is configured to generate personalized outfit suggestions based on user preferences, clothing compatibility, weather conditions, or scheduled user events.

9. The system of claim 1, wherein the system further comprises a sharing functionality allowing users to share and receive feedback on outfit selections through integrated social media platforms.

10. The system of claim 1, further comprising subscription-based access tiers, wherein premium subscribers receive enhanced styling recommendations, increased clothing upload capacity, and priority access to professional stylist advice.

11. A computer-implemented method for generating a physically-accurate virtual rendering of clothing on a user in a networked computing environment, the method comprising:
capturing, by at least one image sensor of a client computing device, a real-time image or video stream of a user;
acquiring, by at least one depth sensor or LiDAR sensor associated with the client computing device, three-dimensional spatial data corresponding to a surface geometry of the user;
generating, by a graphics processing unit (GPU), a three-dimensional mesh model of the user based on the real-time image or video stream and the three-dimensional spatial data;
receiving, from a remote server over a packet-switched network, digital image data corresponding to one or more clothing or footwear items stored in a remote database;
performing, by a convolutional neural network executed on at least one processor, pixel-level segmentation of the digital image data to remove background data and isolate garment regions;
transforming the isolated garment regions into parameterized garment models including dimensional, texture, and deformation parameters;
applying, by a physics-based simulation engine executed by the GPU, a cloth simulation algorithm that models gravitational forces, collision detection, and material properties to deform the parameterized garment models relative to the three-dimensional mesh model of the user;
rendering, by the GPU, a composite image comprising the deformed garment models overlaid on the three-dimensional mesh model of the user in real time;
updating, in response to detected user movement from the image sensor or depth sensor, the three-dimensional mesh model and dynamically recalculating garment deformation using the physics-based simulation engine;
storing, in a non-transitory memory, interaction data comprising user selections, garment combinations, and rendering parameters;
processing, by a recommendation engine executed on the remote server, the interaction data using a trained machine learning model to generate a ranked set of outfit configurations; and
transmitting, over the network, the ranked set of outfit configurations to the client computing device for display,
wherein the method improves rendering accuracy and computational efficiency of real-time garment visualization by integrating sensor-derived geometric data, machine learning-based segmentation, and GPU-accelerated physics simulation.

12. The method of claim 11, wherein the three-dimensional spatial data is acquired using a time-of-flight sensor or LiDAR sensor integrated into a mobile computing device.

13. The method of claim 11, wherein the convolutional neural network is trained using a dataset comprising labeled garment images to improve accuracy of pixel-level segmentation of clothing regions.

14. The method of claim 11, wherein the parameterized garment models include material properties comprising elasticity, stiffness, and friction coefficients used by the physics-based simulation engine.

15. The method of claim 11, wherein the physics-based simulation engine performs collision detection between the parameterized garment models and the three-dimensional mesh model of the user to prevent interpenetration.

16. The method of claim 11, wherein the rendering of the composite image is performed at a frame rate of at least 24 frames per second to enable real-time visualization.

17. The method of claim 11, wherein the interaction data further comprises temporal data indicating a sequence and duration of user-selected outfit combinations.

18. The method of claim 11, wherein the trained machine learning model comprises a neural network configured to generate outfit recommendations based at least in part on historical user interaction data and contextual data.

19. The method of claim 11, wherein the contextual data includes at least one of weather conditions, geographic location, calendar events, or time of day.

20. The method of claim 11, further comprising transmitting at least a portion of the composite image to a remote computing device to enable sharing of outfit configurations via a network-based social platform.
